(19) United States
(12) Patent Application Publication
(10) Pub. No.: US 2025/0029322 A1
(43) Pub. Date: Jan. 23, 2025

(54) VIRTUAL ENVIRONMENT DISPLAY

(71) Applicant: Tencent Technology (Shenzhen) Company Limited, Shenzhen (CN)

(72) Inventors: Weizhe Liu, Shenzhen (CN); Pan Ji, Shenzhen (CN); Hongdong Li, Shenzhen (CN)

(21) Appl. No.: 18/909,592

(22) Filed: Oct. 8, 2024

Related U.S. Application Data
(63) Continuation of application No. PCT/CN2023/134676, filed on Nov. 28, 2023.

(30) Foreign Application Priority Data
Dec. 21, 2022 (CN) 2022116497606

(51) Int. Cl. G06T 15/20; G06T 7/73; G06V 10/46; G06V 10/77; G06V 20/40

(52) U.S. Cl. CPC G06T 15/205; G06T 7/74; G06V 10/46; G06V 10/7715; G06V 20/46; G06T 2207/10016; G06T 2207/20212; G06T 2207/30244

(57) ABSTRACT

A panoramic image formed by projecting a target place to a virtual environment can be generated based on a plurality of environment images obtained by observing the target place from different angles of view. A machine can automatically recognize and intelligently extract layout information of the target place based on the panoramic image, and build, by using the layout information, a target virtual environment for simulating the target place.

### RELATED APPLICATION

This application is a continuation application of PCT Application PCT/CN2023/134676, filed Nov. 28, 2023, which claims priority to Chinese Patent Application No. 202211649760.6 filed on Dec. 21, 2022, each entitled “VIRTUAL ENVIRONMENT DISPLAY METHOD AND APPARATUS, WEARABLE ELECTRONIC DEVICE, AND STORAGE MEDIUM”, and each of which is incorporated herein by reference in its entirety.

### FIELD OF THE TECHNOLOGY

This application relates to the field of computer technologies, and in particular, to a virtual environment display method and apparatus, a wearable electronic device, and a storage medium.

### BACKGROUND OF THE DISCLOSURE

With development of computer technologies, the extended reality (XR) technology generates an integrated virtual environment by using digital information related to vision, hearing, touch, and the like. After wearing a wearable electronic device, a user can control, by using a matching control device such as a control gamepad or a control ring, a virtual image representing the user to perform interaction in the virtual environment to achieve immersive hyper-reality interaction experience.

To better improve immersive interaction experience of a user, a popular research topic for the XR technology is how to build, based on an image or a video stream of a real environment captured by a camera, a virtual environment to be provided by a wearable electronic device after full consent and authorization of the user for permissions to the camera are obtained. Currently, a user needs to manually mark layout information of a real environment in a virtual environment by using a control device. For example, the user manually marks a wall location, a ceiling location, a ground location, and the like. An operation process is complex, and virtual environment building efficiency is low.

### SUMMARY

Examples of this application provide a virtual environment display method and apparatus, a wearable electronic device, and a storage medium. The technical solutions are as follows:

According to an aspect, a virtual environment display method is provided. The method is performed by a wearable electronic device, and the method comprises: obtaining a plurality of environment images, different environment images representing images captured when a camera observes a target place from different angles of view; obtaining, based on the plurality of environment images, a panoramic image formed by projecting the target place to a virtual environment; extracting layout information of the target place in the panoramic image, the layout information comprises boundary information of an object at the target place; and displaying a target virtual environment built based on the layout information, the target virtual environment being a simulation of the target place in the virtual environment.

According to an aspect, a virtual environment display apparatus is provided. The apparatus comprises: a first obtaining module, configured to obtain a plurality of environment images, different environment images representing images captured when a camera observes a target place from different angles of view; a second obtaining module, configured to obtain, based on the plurality of environment images, a panoramic image formed by projecting the target place to a virtual environment; an extraction module, configured to extract layout information of the target place in the panoramic image, the layout information comprises boundary information of an object at the target place; and a display module, configured to display a target virtual environment built based on the layout information, the target virtual environment being a simulation of the target place in the virtual environment.

In some examples, the second obtaining module comprises: a detection unit, configured to perform key point detection on the plurality of environment images to obtain location information of a plurality of image key points at the target place in the plurality of environment images respectively; a determining unit, configured to determine a plurality of camera poses of the plurality of environment images respectively based on the location information, the camera poses being configured for indicating angle-of-view rotation attitudes of the camera during capturing of the environment images; a first projection unit, configured to respectively project, based on the plurality of camera poses, the plurality of environment images from an original coordinate system of the target place to a spherical coordinate system of the virtual environment to obtain a plurality of projected images; and an obtaining unit, configured to obtain the panoramic image formed by splicing the plurality of projected images.

In some examples, the determining unit is configured to: set amounts of movement of the plurality of camera poses to zero; and determine, based on the location information, amounts of rotation of the plurality of camera poses of the plurality of environment images respectively.

In some examples, the first projection unit is configured to: modify the plurality of camera poses, so that the plurality of camera poses are aligned at a spherical center of the spherical coordinate system; and respectively project the plurality of environment images from the original coordinate system to the spherical coordinate system based on a plurality of modified camera poses to obtain the plurality of projected images.

In some examples, the obtaining unit is configured to: splice the plurality of projected images to obtain a spliced image; and perform at least one of smoothing or light compensation on the spliced image to obtain the panoramic image.

In some examples, the detection unit is configured to: perform key point detection on each environment image to obtain location coordinates of each of a plurality of image key points in each environment image; and pair a plurality of location coordinates of a same image key point in the plurality of environment images to obtain location information of each image key point, the location information of each image key point being configured for indicating location coordinates of each image key point in the plurality of environment images.

In some examples, the extraction module includes a second projection unit, configured to project a vertical direction of the panoramic image as a gravity direction to obtain a modified panoramic image; an extraction unit, configured to extract an image semantic feature of the modified panoramic image, the image semantic feature being configured for representing semantic information, in the modified panoramic image, that is associated with the object at the target place; and a prediction unit, configured to predict the layout information of the target place in the panoramic image based on the image semantic feature.

In some examples, the extraction unit includes: an input subunit, configured to input the modified panoramic image to a feature extraction model; a first convolution subunit, configured to perform a convolution operation on the modified panoramic image through one or more convolutional layers in the feature extraction model to obtain a first feature map; a second convolution subunit, configured to perform a depthwise separable convolution operation on the first feature map through one or more depthwise separable convolutional layers in the feature extraction model to obtain a second feature map; and a post-processing subunit, configured to perform at least one of a pooling operation or a full connection operation on the second feature map through one or more post-processing layers in the feature extraction model to obtain the image semantic feature.

In some examples, the second convolution subunit is configured to: perform a spatial-dimension per-channel convolution operation on an output feature map of a previous depthwise separable convolutional layer through each depthwise separable convolutional layer to obtain a first intermediate feature, the first intermediate feature having the same dimensionality as that of the output feature map of the previous depthwise separable convolutional layer; perform a channel-dimension per-point convolution operation on the first intermediate feature to obtain a second intermediate feature; perform a convolution operation on the second intermediate feature to obtain an output feature map of the depthwise separable convolutional layer; and iteratively perform the per-channel convolution operation, the per-point convolution operation, and the convolution operation, so that a last depthwise separable convolutional layer outputs the second feature map.

In some examples, the prediction unit includes: a division subunit, configured to perform a channel-dimension division operation on the image semantic feature to obtain a plurality of spatial-domain semantic features; an encoding subunit, configured to input the plurality of spatial-domain semantic features to a plurality of memory units of a layout information extraction model respectively, and encode the plurality of spatial-domain semantic features through the plurality of memory units to obtain a plurality of spatial-domain context features; and a decoding subunit, configured to decode the plurality of spatial-domain context features to obtain the layout information.

In some examples, the encoding subunit is configured to: through each memory unit, encode a spatial-domain semantic feature associated with the memory unit and a spatial-domain preceding-context feature obtained through encoding by a previous memory unit, and input an encoded spatial-domain preceding-context feature to a next memory unit; encode the spatial-domain semantic feature associated with the memory unit and a spatial-domain following-context feature obtained through encoding by the next memory unit, and input an encoded spatial-domain following-context feature to the previous memory unit; and obtain, based on the spatial-domain preceding-context feature and the spatial-domain following-context feature that are obtained through encoding by the memory unit, a spatial-domain context feature outputted by the memory unit.

In some examples, the first obtaining module is configured to: obtain a video stream captured by the camera after an angle of view of the camera rotates by one circle within a target range of the target place; and perform sampling from a plurality of image frames included in the video stream to obtain the plurality of environment images.

In some examples, the layout information includes a first layout vector, a second layout vector, and a third layout vector, the first layout vector indicating information of a junction between a wall and a ceiling at the target place, the second layout vector indicating information of a junction between a wall and a ground at the target place, and the third layout vector indicating information of a junction between walls at the target place.

In some examples, the camera is a monocular camera or a binocular camera on the wearable electronic device.

In some examples, the apparatus further includes: a material recognition module, configured to perform material recognition on the object at the target place based on the panoramic image to obtain a material of the object; and an audio modification module, configured to modify, based on the material of the object, at least one of sound quality or a volume of audio associated with the virtual environment.

According to an aspect, a wearable electronic device is provided, the wearable electronic device including one or more processors and one or more memories, the one or more memories storing at least one computer program, and the at least one computer program being loaded and executed by the one or more processors to implement the foregoing virtual environment display method.

According to an aspect, a non-transitory computer-readable storage medium is provided, the computer-readable storage medium storing at least one computer program, and the at least one computer program being loaded and executed by a processor to implement the foregoing virtual environment display method.

According to an aspect, a computer program product is provided, the computer program product including one or more computer programs, and the one or more computer programs being stored in a computer-readable storage medium. One or more processors of a wearable electronic device are capable of reading the one or more computer programs from the computer-readable storage medium, and the one or more processors execute the one or more computer programs, so that the wearable electronic device can perform the foregoing virtual environment display method.

The technical solutions provided in examples of this application have at least the following beneficial effects:

A panoramic image formed by projecting a target place to a virtual environment is generated based on a plurality of environment images obtained by observing the target place from different angles of view. A machine can automatically recognize and intelligently extract layout information of the target place based on the panoramic image, and build, by using the layout information, a target virtual environment for simulating the target place. In this way, because the machine can automatically extract the layout information and build the target virtual environment without manually marking the layout information by a user, an entire process takes quite a short time, and a virtual environment building speed and virtual environment loading efficiency are greatly improved. In addition, the target virtual environment can highly restore the target place, so that immersive interaction experience of a user can be improved.

### BRIEF DESCRIPTION OF THE DRAWINGS

FIG. 1 is a schematic diagram of an implementation environment of a virtual environment display method according to an example of this application.

FIG. 2 is a flowchart of a virtual environment display method according to an example of this application.

FIG. 3 is a schematic flowchart of capturing an environment image according to an example of this application.

FIG. 4 is a schematic diagram of environment images at different angles of view according to an example of this application.

FIG. 5 is a schematic diagram of projecting an environment image to a projected image according to an example of this application.

FIG. 6 is a schematic diagram of a 360-degree panoramic image according to an example of this application.

FIG. 7 is a schematic diagram of a target virtual environment according to an example of this application.

FIG. 8 is a schematic diagram of an audio propagation mode in three-dimensional virtual space according to an example of this application.

FIG. 9 is a flowchart of a virtual environment display method according to an example of this application.

FIG. 10 is a schematic diagram of an initial panoramic image captured by a panoramic camera according to an example of this application.

FIG. 11 is a schematic diagram of a shift and disturbance at a center of a camera according to an example of this application.

FIG. 12 is a schematic diagram of environment images at different angles of view according to an example of this application.

FIG. 13 is a schematic flowchart of pairing image key points according to an example of this application.

FIG. 14 is an expanded view of a 360-degree panoramic image according to an example of this application.

FIG. 15 is a processing flowchart of a panoramic image construction algorithm according to an example of this application.

FIG. 16 is a schematic diagram of bidirectional encoding in a bidirectional long short-term memory (BLSTM) architecture according to an example of this application.

FIG. 17 is a schematic diagram of marking layout information in a 360-degree panoramic image according to an example of this application.

FIG. 18 is a processing flowchart of obtaining layout information according to an example of this application.

FIG. 19 is a top view of a target virtual environment according to an example of this application.

FIG. 20 is a flowchart of three-dimensional layout understanding for a target place according to an example of this application.

FIG. 21 is a schematic structural diagram of a virtual environment display apparatus according to an example of this application.

FIG. 22 is a schematic structural diagram of a wearable electronic device according to an example of this application.

### DETAILED DESCRIPTION

When applied to a specific product or technology with a method in this application, user-related information (including but not limited to device information, personal information, and behavioral information of a user, and the like), data (including but not limited to data for analysis, stored data, displayed data, and the like), and signals in this application are used under permission, consent, and authorization by users or full authorization by all parties. In addition, collection, use, and processing of related information, data, and signals need to comply with related laws, regulations, and standards in related countries and regions. For example, all environment images in this application are obtained under full authorization.

Terms in this application are explained and described below.

Extended reality (XR): XR is to build a virtual environment for human-computer interaction by combining reality and virtuality through a computer. In addition, the XR technology is also a collective term for a plurality of technologies such as virtual reality (VR), augmented reality (AR), and mixed reality (MR). The three visual interaction technologies are integrated to bring an experiencer a “sense of immersion” based on seamless switching between a virtual world and the real world.

VR: VR is a computer simulation system that can create and experience a virtual environment. The VR technology includes a computer, electronic information, and a simulation technology. A basic implementation thereof is to produce a realistic three-dimensional virtual environment with multi-sensory experience such as vision, touch, and smell through devices such as a computer by mainly using a computer technology, in combination with a plurality of latest high-tech development achievements such as a three-dimensional graphics technology, a multimedia technology, a simulation technology, a display technology, and a servo technology, to combine virtuality and reality, so that a person in the virtual environment feels a sense of immersion.

AR: The AR technology is a technology that skillfully integrates virtual information with the real world. It simulates computer-generated virtual information such as text, images, three-dimensional models, music, and videos by extensively using a variety of technical means such as multimedia, three-dimensional modeling, real-time following and registration, intelligent interaction, and sensing, and then applies the virtual information to the real world. Two types of information complement each other to “augment” the real world.

MR: The MR technology is a further development of the VR technology. The MR technology builds an interactive feedback information loop between the real world, a virtual world, and a user by displaying real scene information in a virtual scene, to enhance a sense of reality of user experience.

Head-mounted display (HMD): The HMD may transmit an optical signal to eyes to achieve different effects for VR, AR, MR, XR, and the like. The HMD is an example of a wearable electronic device. For example, in a VR scenario, the HMD may be implemented as VR glasses, a VR eye mask, a VR helmet, or the like. A display principle of the HMD is as follows: A left-eye screen and a right-eye screen display a left-eye image and a right-eye image respectively, and a three-dimensional sense is produced in mind after human eyes obtain the information with differences.

Operation gamepad: The operation gamepad is an input device matching a wearable electronic device. A user can control, by using the operation gamepad, a virtual image of the user that is visualized in a virtual environment provided by the wearable electronic device. The operation gamepad may be configured with a joystick and physical buttons with different functions according to service requirements. For example, the operation gamepad includes a joystick, an OK button, or other function buttons.

Operation ring: The operation ring is another input device matching a wearable electronic device and has a product form different from that of the operation gamepad. The operation ring is also referred to as an intelligent ring, and may be configured to wirelessly control the wearable electronic device, with high operation convenience. The operation ring may be configured with an optical finger navigation (OFN) dashboard, so that a user can input a control instruction based on OFN.

Virtual environment: The virtual environment is displayed (or provided) when an XR application is run on a wearable electronic device. The virtual environment may be a simulated environment of the real world, a semi-simulated and semi-fictional virtual environment, or a purely fictional virtual environment. The virtual environment may be any one of a two-dimensional virtual environment, a 2.5-dimensional virtual environment, or a three-dimensional virtual environment. Dimensionality of the virtual environment is not limited in the examples of this application. When a user enters the virtual environment, the user may create a virtual image for representing the user.

Virtual image: The virtual image is a movable object that is controlled by a user in a virtual environment and that represents the user. In some examples, the user may select one of a plurality of preset images provided by an XR application as a virtual image of the user, or may adjust a look or an appearance of a selected virtual image, or may create a personalized virtual image through face adjustment or the like. An appearance of the virtual image is not specifically limited in the examples of this application. For example, the virtual image is a three-dimensional model, and the three-dimensional model is a three-dimensional character built based on a three-dimensional human skeleton technology. The virtual image may show different external images by wearing different skins.

Virtual object: The virtual object is movable object occupying some space in a virtual environment other than a user-controlled virtual image. For example, the virtual object includes indoor facilities projected to a virtual scene based on an environment image of a target place, and the indoor facilities include virtual items such as a wall, a ceiling, a ground, furniture, and an electrical appliance. For another example, the virtual object further includes other visual virtual objects generated by a system, for example, a non-player character (NPC) or an AI object controlled by an AI behavior model.

Field of view (FoV): The FoV is a range of a scene (or a field of vision or a viewfinder coverage) seen when a virtual environment is observed from an angle of view of a specific viewpoint. For example, for a virtual image in a virtual environment, a viewpoint is eyes of the virtual image, and the FoV is a field of vision that the eyes can observe in the virtual environment. For another example, for a camera in the real world, a viewpoint is a lens of the camera, and the FoV is a viewfinder coverage of the lens to observe a target place in the real world. Generally, a smaller FoV indicates a smaller range and higher concentration of a scene observed in the FoV and higher amplification of an object in the FoV, and a larger FoV indicates a larger range and lower concentration of a scene observed in the FoV and lower amplification of an object in the FoV.

Three-dimensional room layout understanding technology: The three-dimensional room layout understanding technology is a technology in which, after a user wears a wearable electronic device, for example, an XR device such as VR glasses or a VR helmet, and full consent and full authorization of the user for camera permissions are obtained, a camera of the wearable electronic device is turned on to capture a plurality of environment images of a target place at which the user is located in the real world from a plurality of angles of view, and automatically recognize and understand layout information of the target place to output layout information of the target place projected to a virtual environment. The environment image carries at least a picture, a location, and other information of the target place (for example, a room) in the real world. In an example in which the target place is a room, the layout information of the target place includes but is not limited to locations, sizes, orientations, semantics, and other information of indoor facilities such as a ceiling, a wall, a ground, a door, and a window.

In a virtual environment display method provided in the examples of this application, an environment image of a target place at which a user is located in the real world may be captured by a camera on a wearable electronic device, to automatically construct a 360-degree panoramic image formed by projecting the target place to a spherical coordinate system of a virtual environment. In this way, all-round automatic machine understanding for a three-dimensional layout of the target place can be implemented based on the panoramic image. For example, locations of a ceiling, a wall, and a ground and coordinates of junctions at the target place may be automatically parsed out. Then a mapping of the target place in the virtual environment may be constructed based on the three-dimensional layout of the target place. This improves virtual environment building efficiency and display effects, and achieves in-depth virtual-reality interaction experience.

In addition, the camera of the wearable electronic device may be a conventional monocular camera. The three-dimensional layout of the target place can be accurately understood without specially configuring a depth sensor or a binocular camera or specially configuring an expensive panoramic camera. This greatly reduces costs and energy consumption of the device. Certainly, the three-dimensional room layout understanding technology can also adapt to a binocular camera and a panoramic camera, with high portability and high availability.

A system architecture of the examples of this application are described below.

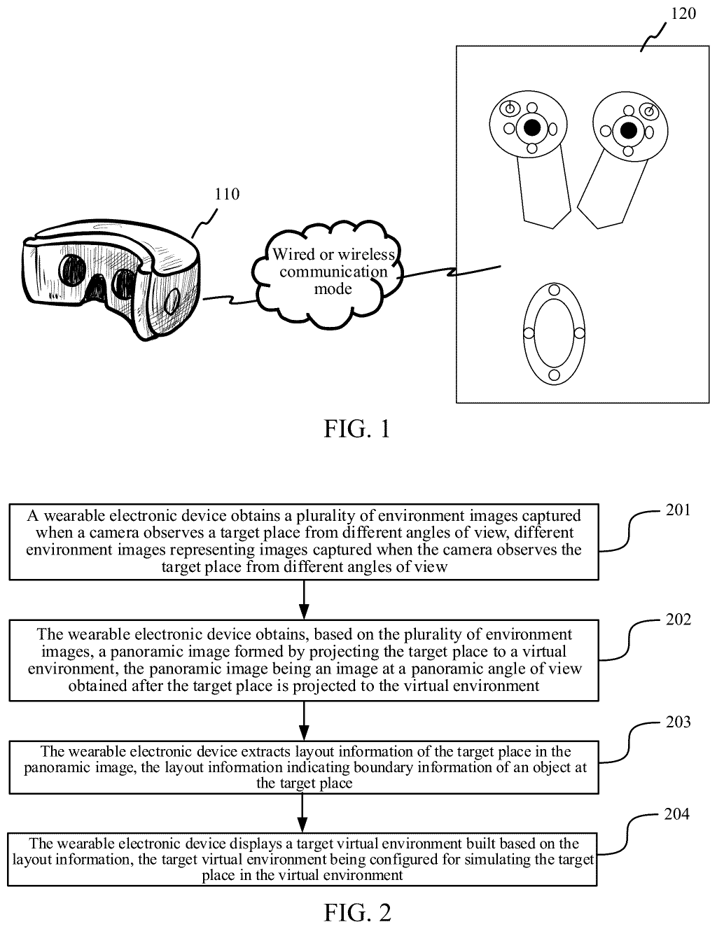

FIG. 1 is a schematic diagram of an implementation environment of a virtual environment display method according to an example of this application. As shown in FIG. 1, this example is applied to an XR system, and the XR system includes a wearable electronic device 110 and a control device 120. Descriptions are provided below.

An application that supports an XR technology is installed and run on the wearable electronic device 110. In some examples, the application may be an XR application, a VR application, an AR application, an MR application, a social application, a game application, an audio/video application, or the like that supports the XR technology. An application type is not specifically limited herein.

In some examples, the wearable electronic device 110 may be a head-mounted electronic device such as an HMD, VR glasses, a VR helmet, or a VR eye mask, or may be another wearable electronic device configured with a camera or capable of receiving image data captured by a camera, or may be another electronic device that supports the XR technology, for example, a smartphone, a tablet computer, a notebook computer, a desktop computer, a smart speaker, or a smart watch that supports the XR technology, but is not limited thereto.

A user can observe, by using the wearable electronic device 110, a virtual environment built by using the XR technology and create a virtual image for representing the user in the virtual environment, and can further interact, battle, and socialize with other virtual images created by other users in the same virtual environment.

The wearable electronic device 110 and the control device 120 may be directly or indirectly connected through wired or wireless communication. This is not limited in this application.

The control device 120 is configured to control the wearable electronic device 110. If the wearable electronic device 110 and the control device 120 are wirelessly connected, the control device 120 may remotely control the wearable electronic device 110.

In some examples, the control device 120 may be a portable device or a wearable device such as a control gamepad, a control ring, a control watch, a control wristband, a control finger ring, or a glove control device. The user may input a control instruction by using the control device 120. The control device 120 transmits the control instruction to the wearable electronic device 110, so that the wearable electronic device 110 controls, in response to the control instruction, the virtual image in the virtual environment to perform a corresponding action or behavior.

In some examples, the wearable electronic device 110 may further establish a wired or wireless communication connection to an XR server, so that users around the world can enter a same virtual environment through the XR server to implement “meeting across time and space”. The XR server may further provide other displayable multimedia resources for the wearable electronic device 110. This is not specifically limited herein.

The XR server may be an independent physical server, a server cluster or a distributed system that includes a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

A basic processing process of the virtual environment display method provided in examples of this application is described below.

FIG. 2 is a flowchart of a virtual environment display method according to an example of this application. As shown in FIG. 2, this example is performed by a wearable electronic device, and this example includes the following operations (e.g., steps, methods):
201: The wearable electronic device obtains a plurality of environment images captured when a camera observes a target place from different angles of view, different environment images representing images captured when the camera observes the target place from different angles of view.

The camera in examples of this application may be a monocular camera or a binocular camera, or may be a panoramic camera or a non-panoramic camera. A type of the camera is not specifically limited in the examples of this application.

In some examples, after a user wears a wearable electronic device and full consent and full authorization of the user for permissions to a camera are obtained, the wearable electronic device turns on the camera, and the user may rotate in place by one circle at a location of the user at a target place, or the user walks around the target place by one circle, or the user walks to a plurality of specified locations (for example, four corners and a center of a room) for photographing, or an XR system guides, by using a guidance voice, a guidance image, or a guidance animation, the user to make different body postures to capture environment images at different angles of view, to finally capture a plurality of environment images in a case in which the target place is observed from different angles of view. A body posture of the user during capturing of an environment image is not specifically limited in the examples of this application.

In some examples, an example in which the user rotates in place by one circle to capture an environment image is used for description. The camera captures an environment image at intervals of equal or non-equal rotational angles. In this way, a plurality of environment images can be captured after the camera rotates by one circle. In an example, the camera captures an environment image at intervals of 30-degree rotational angles. The user captures a total of 12 environment images during rotation by one circle, namely, 360 degrees.

In some examples, the camera captures a video stream of the observed target place in real time and samples a plurality of image frames from the captured video stream as the plurality of environment images. Image frames may be sampled at equal or non-equal spacings. For example, an image frame is selected as an environment image at intervals of N (N≥1) frames; or a rotational angle of each image frame is determined based on a simultaneous localization and mapping (SLAM) system of the camera, and image frames are evenly selected at different rotational angles. A manner of sampling image frames from a video stream is not specifically limited in the examples of this application.

In some other examples, an external camera may alternatively capture a plurality of environment images and transmit the plurality of environment images to the wearable electronic device, so that the wearable electronic device obtains the plurality of environment images. A source of the plurality of environment images is not specifically limited in the examples of this application.

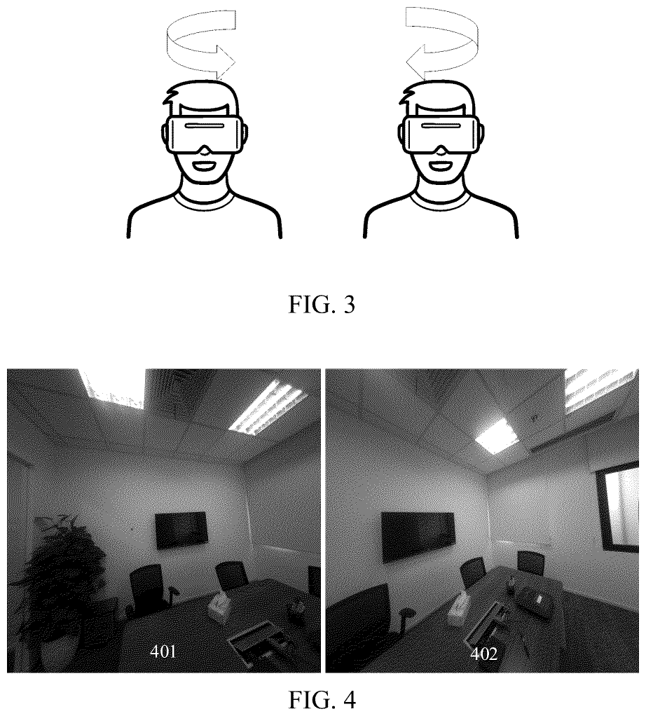

As shown in FIG. 3, for example, the wearable electronic device is a VR head-mounted display. After wearing the VR head-mounted display, a user keeps looking straight ahead, controls the VR head-mounted display to turn on a camera, and rotates in place by one circle along a horizontal direction (in other words, rotates 360 degrees). A rotation direction may be clockwise rotation (e.g., rotation to the right) or counterclockwise rotation (e.g., rotation to the left). The rotation direction of the user is not specifically limited in examples of this application. The camera of the VR head-mounted display directly captures a plurality of environment images during rotation, or directly captures a video stream to sample a plurality of environment images from the video stream. Because the user rotates in place, a plurality of environment images selected during rotation may be considered as a series of images captured at a same place by observing a target place from different angles of view.

As shown in FIG. 4, for example, the target place is a target room. A user captures a plurality of environment images after wearing a VR head-mounted display in the target room and rotating in place by one circle. FIG. 4 shows two environment images 401 and 402 among the plurality of environment images. The environment images 401 and 402 can be approximately considered as images of a same place observed from different angles of view, and can be used by the VR head-mounted display to extract layout information of the target place.
202: The wearable electronic device obtains, based on the plurality of environment images, a panoramic image formed by projecting the target place to a virtual environment, the panoramic image being an image obtained at a panoramic angle of view after the target place is projected to the virtual environment.

In some examples, the wearable electronic device constructs a 360-degree panoramic image of the target place based on the plurality of environment images obtained in operation 201, and eliminates an error resulting from a location change caused by camera disturbance. The 360-degree panoramic image is a panoramic image formed by projecting, to a spherical surface with a center of the camera as a spherical center, a target place indicated by an environment image captured through 360-degree rotation along a horizontal direction and 180-degree rotation along a vertical direction. For example, the target place is projected from an original coordinate system in the real world to a spherical coordinate system with the center of the camera as a spherical center in the virtual environment, to convert the plurality of environment images into the 360-degree panoramic image.

In some examples, for each environment image, a camera pose during capturing of the environment image can be determined based on the SLAM system of the camera, and after the camera pose is determined, the environment image may be projected from the original coordinate system to the spherical coordinate system by using a projection matrix of the camera. After the foregoing projection operation is performed on all environment images, projected images of all the environment images may be spliced in the spherical coordinate system to obtain the panoramic image.

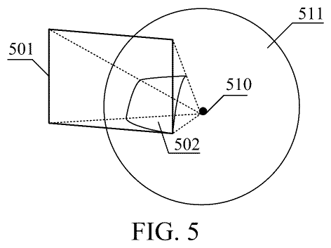

As shown in FIG. 5, for an environment image 501 in a rectangular shape in the original coordinate system, after a camera pose during capturing of the environment image 501 is determined, a parameter of the projection matrix of the camera may be determined, and the environment image 501 is projected, based on the parameter of the projection matrix, to a spherical surface 511 with the center (namely, a lens) of the camera as a spherical center 510, to obtain a projected image 502 formed through projection to the spherical surface 511.

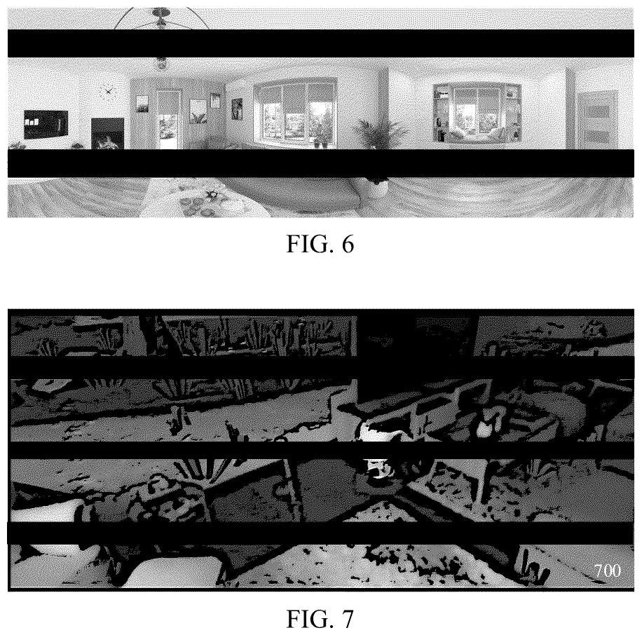

As shown in FIG. 6, a 360-degree panoramic image is provided, and the 360-degree panoramic image can fully show a layout of the target place at various angles of view. During rotation of the camera by one circle, a viewing angle in a horizontal direction is 0-360 degrees, and a pitch angle in a vertical direction is 0-180 degrees. Horizontal coordinates of a 360-degree panoramic image generated in this case are expressed as a field of view ranging from 0 degrees to 360 degrees in the horizontal direction, and vertical coordinates of the 360-degree panoramic image are expressed as a field of view ranging from 0 degrees to 180 degrees in the vertical direction. Therefore, a width-to-height ratio of the 360-degree panoramic image is 2:1.
203: The wearable electronic device extracts layout information of the target place in the panoramic image, the layout information indicating boundary information of an object at the target place.

The object at the target place may be an object that is located at the target place and that occupies specific space. For example, the target place may be an indoor place, and the object at the target place may be indoor facilities at the indoor place, such as a wall, a ceiling, a ground, furniture, and an electrical appliance.

In some examples, the wearable electronic device may train a feature extraction model and a layout information extraction model, and first extract an image semantic feature of the panoramic image by using the feature extraction model, and then extract the layout information of the target place by using the image semantic feature. Exemplary structures of the feature extraction model and the layout information extraction model are described in detail in a next example. Details are not described herein.

In some examples, the layout information includes at least location information of a junction between walls, a junction between a wall and a ceiling, and a junction between a wall and a ground at the target place, the layout information may be expressed as three one-dimensional spatial layout vectors. The three one-dimensional spatial layout vectors can indicate location coordinates of the junctions and necessary height information.
204: The wearable electronic device displays a target virtual environment built based on the layout information, the target virtual environment being configured for simulating the target place in the virtual environment.

In some examples, the wearable electronic device builds, based on the layout information extracted in operation 203, the target virtual environment for simulating the target place. Then the wearable electronic device displays the target virtual environment, so that the user can feel like entering the target place in the real world in the target virtual environment. This helps provide more immersive hyper-reality interaction experience.

As shown in FIG. 7, in an XR game development scenario, after a user wears an XR head-mounted display and rotates in place by one circle, the XR head-mounted display extracts layout information of a target place based on a plurality of environment images captured by a camera, builds a target virtual environment 700 based on the layout information, and finally displays the target virtual environment 700.

The building a target virtual environment based on the layout information may include: determining a location of a wall based on a spatial layout vector in the layout information, and deploying a virtual scene in the virtual environment at the location of the wall, to replace a wall in a real environment with the virtual scene in the virtual environment.

The building a target virtual environment based on the layout information may further include: determining a location of a ground based on a spatial layout vector in the layout information, and deploying a virtual object in the virtual environment at the location of the ground, to generate a new virtual object at a ground in a real environment.

Because the layout information can provide at least a wall location at the target place, a virtual wall indicated by the wall location may be projected to a virtual scene (for example, forest or grassland) in the target virtual environment 700, to expand a field of vision of the user in a game without increasing a floor area of the target place. Further, because the layout information can further provide a ground location at the target place, some virtual objects, virtual items, game props, and the like may be place on a virtual ground in the target virtual environment 700, and the virtual objects can be further controlled to perform activities on the virtual ground to achieve more diversified game effects.

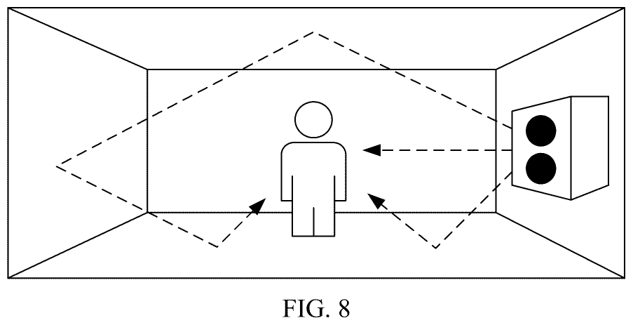

As shown in FIG. 8, in a scenario of a spatial audio technology in a game, layout information of a target place may be configured for not only constructing a picture of a target virtual environment, but also adjusting audio matching the target virtual environment. For example, sound transmitted indoors in the real world varies due to different layouts or materials of the target place. For example, door closing sound varies due to different distances between a door and a user. For another example, sound of footsteps on a wooden floor is different from sound of footsteps on a tile floor. The layout information of the target place can help determine distances between the user and various objects indoors (for example, indoor facilities), to facilitate adjustment of a volume of game audio. In addition, materials of the indoor facilities can also be obtained. In this way, different spatial audio can be used during game development to provide sound quality matching indoor facilities made of different materials. This can further enhance a sense of immersion of the user during use.

All of the foregoing technical solutions can be combined in any manner to form some examples of the present disclosure. Details are not described herein.

In the method provided in examples of this application, a panoramic image formed by projecting a target place to a virtual environment is generated based on a plurality of environment images obtained by observing the target place from different angles of view. A machine can automatically recognize and intelligently extract layout information of the target place based on the panoramic image, and build, by using the layout information, a target virtual environment for simulating the target place. In this way, because the machine can automatically extract the layout information and build the target virtual environment without manually marking the layout information by a user, an entire process takes quite a short time, and a virtual environment building speed and virtual environment loading efficiency are greatly improved. In addition, the target virtual environment can highly restore the target place, so that immersive interaction experience of a user can be improved.

Usually, a process of automatically understanding a three-dimensional layout of a target place by a machine takes only a few seconds, and a user does not need to manually mark boundary information, so that a layout information extraction speed is greatly increased. In addition, an environment image may be captured merely by using an ordinary monocular camera, without necessarily requiring that a special panoramic camera be configured or a depth sensor module be added. Therefore, the method requires low hardware costs and low energy consumption of a wearable electronic device, and can be widely deployed on wearable electronic devices with various hardware specifications.

In addition, the room layout understanding technology for a target place may be encapsulated into an interface to support various external applications such as an MR application, an XR application, a VR application, and an AR application. For example, a virtual object is placed on a virtual ground in a target virtual environment, and a virtual wall and a virtual ceiling in the target virtual environment are projected as a virtual scene to expand a field of vision of a user. In addition, based on the room layout understanding technology and the material-based spatial audio technology, a user can have more immersive interaction experience while using a wearable electronic device.

In the foregoing example, a processing process of the virtual environment display method is briefly described. In this example of this application, specific examples of the operations in the virtual environment display method are described in detail. Descriptions are provided below.

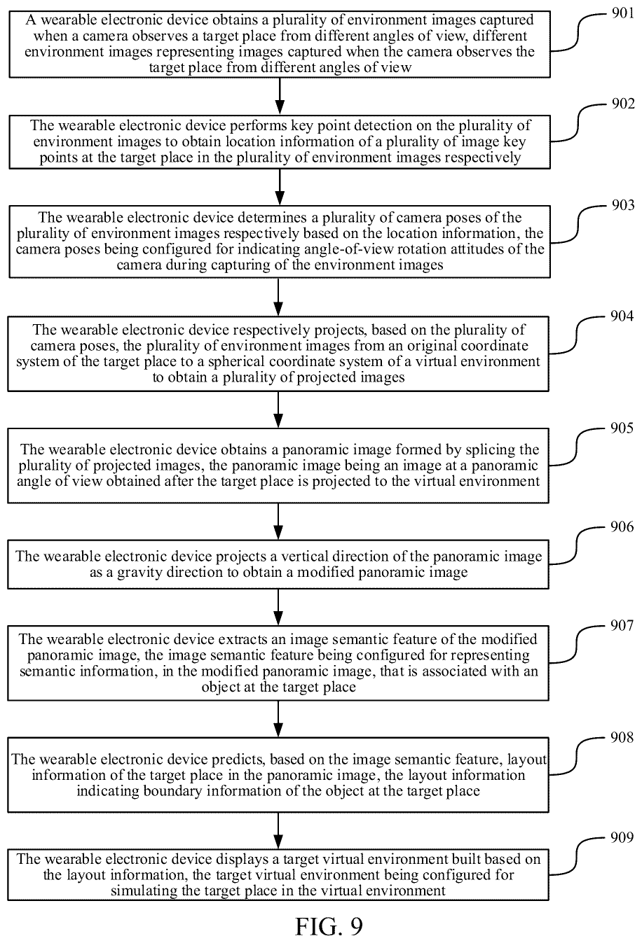

FIG. 9 is a flowchart of a virtual environment display method according to an example of this application. As shown in FIG. 9, this example is performed by a wearable electronic device, and this example includes the following operations:
901: The wearable electronic device obtains a plurality of environment images captured when a camera observes a target place from different angles of view, different environment images representing images captured when the camera observes the target place from different angles of view.

In some examples, the camera is a monocular camera, a binocular camera, a panoramic camera, or a non-panoramic camera on the wearable electronic device. A type of the camera that comes with the wearable electronic device is not specifically limited in examples of this application.

In some examples, after a user wears a wearable electronic device and full consent and full authorization of the user for permissions to a camera are obtained, the wearable electronic device turns on the camera, and the user may rotate in place by one circle at a location of the user at a target place, or the user walks around the target place by one circle, or the user walks to a plurality of specified locations (for example, four corners and a center of a room) for photographing, or an XR system guides, by using a guidance voice, a guidance image, or a guidance animation, the user to make different body postures to capture environment images at different angles of view, to finally capture a plurality of environment images in a case in which the target place is observed from different angles of view. A body posture of the user during capturing of an environment image is not specifically limited in the examples of this application.

In some examples, for example, the user rotates in place by one circle to capture an environment image. The camera captures an environment image at intervals of equal or non-equal rotational angles. In this way, a plurality of environment images can be captured after the camera rotates by one circle. In an example, the camera captures an environment image at intervals of 30-degree rotational angles. The user captures a total of 12 environment images during rotation by one circle, namely, 360 degrees.

In some examples, the camera captures a video stream of the observed target place in real time, so that the wearable electronic device obtains a video stream captured by the camera after an angle of view of the camera rotates by one circle within a target range of the target place. The target range is a range within which the user rotates in place. Because a location of the user may change during rotation in place by one circle, the user is located within a range rather than at a point during rotation. Then a plurality of image frames included in the video stream may be sampled to obtain the plurality of environment images. For example, image frames may be sampled at equal or non-equal spacings. For example, an image frame is selected as an environment image at intervals of N (N≥1) frames; or a rotational angle of each image frame is determined based on a simultaneous localization and mapping (SLAM) system of the camera, and image frames are evenly selected at different rotational angles. A manner of sampling image frames from a video stream is not specifically limited in the examples of this application.

In the foregoing process, image frames are sampled from the video stream as environment images. In this way, a sampling spacing can be flexibly controlled according to a panoramic image construction requirement, so that an environment image selection manner can better meet diversified service requirements, to improve accuracy and controllability for obtaining environment images.

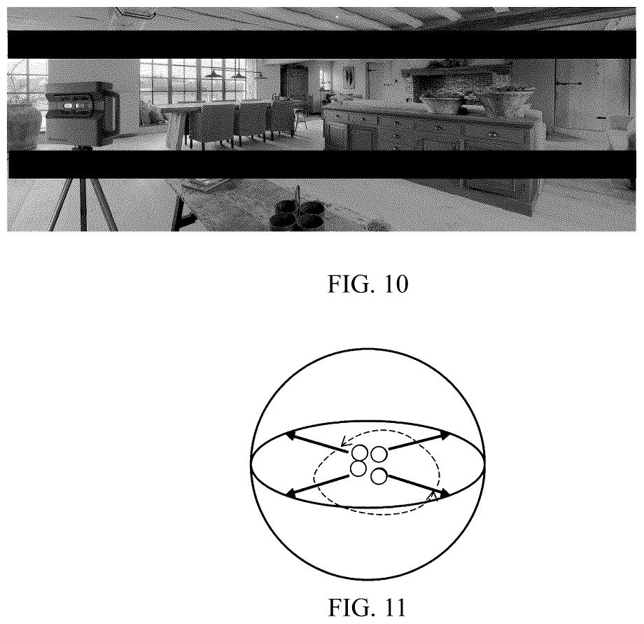

In some other examples, an external camera may alternatively capture a plurality of environment images and transmit the plurality of environment images to the wearable electronic device, so that the wearable electronic device obtains the plurality of environment images. A source of the plurality of environment images is not specifically limited in the examples of this application. As shown in FIG. 10, an external panoramic camera carrying a support may be used to directly capture an initial panoramic image, and a required panoramic image may be obtained only by projecting the captured initial panoramic image from an original coordinate system to a spherical coordinate system. This can simplify a process of obtaining the panoramic image and improve efficiency of obtaining the panoramic image. In addition, because the panoramic camera carries a support, disturbance of coordinates of a spherical center caused by a location change of a user can be eliminated, to reduce some random errors.
902: The wearable electronic device performs key point detection on the plurality of environment images to obtain location information of a plurality of image key points at the target place in the plurality of environment images respectively.

In some examples, for the plurality of environment images captured in operation 901, because a location of the user inevitably changes during rotation, a center of the camera is not a spherical center with a fixed location during rotation by one circle, but a spherical center whose location constantly changes within the target range. Disturbance caused by a location change of the spherical center causes specific difficulty to construction of the panoramic image.

As shown in FIG. 11, four dots represent the center of the camera, and directions of arrows of solid lines starting from the dots represent angles of view during capturing of image frames. Locations of the center of the camera do not completely overlap when the center of the camera rotates by one circle, but inevitably shift during rotation. The center of the camera is not a constant point, and a moving direction of the center of the camera cannot always remain horizontal, but has specific disturbance. In view of this, examples of this application provide a process of obtaining a panoramic images by using an environment image captured by a monocular camera as an example, to minimize disturbance and an error caused by shaking of a lens during rotation of a user.

In some examples, the wearable electronic device may perform key point detection on each environment image to obtain location coordinates of each of a plurality of image key points in each environment image. The image key points are pixels carrying a large amount of information in the environment image, and are usually pixels that are likely to attract attention visually. For example, the image key points are edge points of some objects (for example, indoor facilities), or some colorful pixels. In some examples, key point detection is performed on each environment image by using a key point detection algorithm to output location coordinates of each of a plurality of image key points included in a current environment image. The key point detection algorithm is not specifically limited herein either.

In some examples, the wearable electronic device may pair a plurality of location coordinates of a same image key point in the plurality of environment images to obtain location information of each image key point, the location information of each image key point being configured for indicating a plurality of location coordinates of each image key point in the plurality of environment images. An image key point carries rich information and is highly recognizable. This can facilitate pairing for a same image key point in different environment images. For example, when the target place is observed from different angles of view, a same image key point usually appears at different locations in different environment images. A key point pairing process is to select location coordinates of a same image key point in different environment images to form a group of location coordinates, and use the group of location information as location information of the image key point.

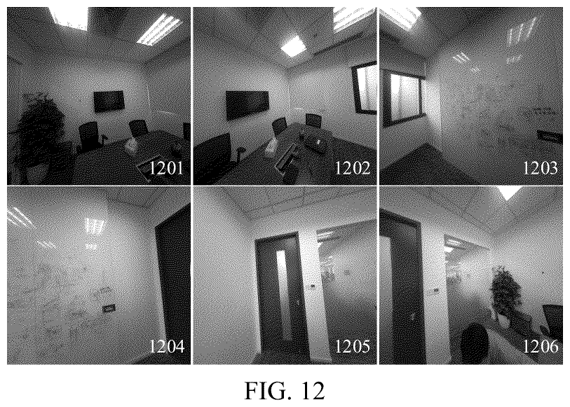

As shown in FIG. 12, key point detection is sequentially performed on six environment images 1201 to 1206 to obtain a plurality of image key points included in each environment image. Then same image key points in different environment images are paired. After the pairing succeeds, each image key point has a group of location coordinates as location information, to indicate location coordinates of each image key point in different environment images.

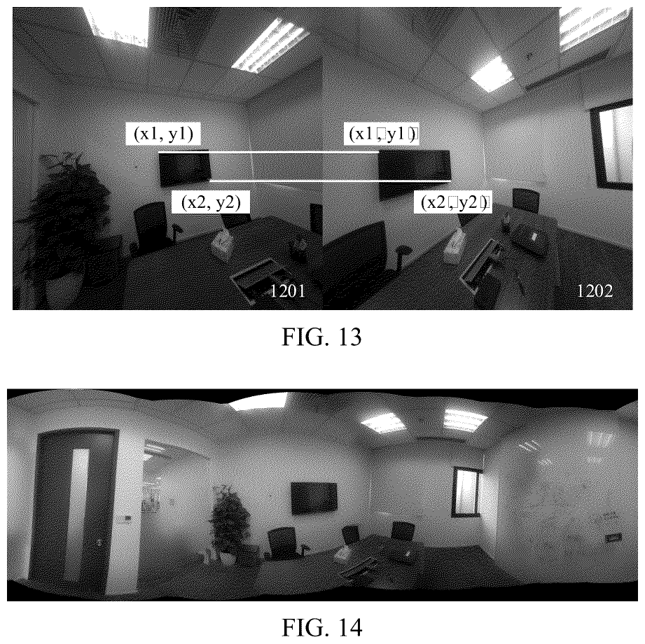

As shown in FIG. 13, for environment images 1201 and 1202, it is assumed that an upper-left vertex and a lower-right vertex of a television are both recognized by the key point detection algorithm as image key points. In this case, in a key point detection stage, location coordinates (x1, y1) and (x2, y2) of the upper-left vertex and the lower-right vertex of the television in the environment image 1201 and location coordinates (x1′, y1′) and (x2′, y2′) of the upper-left vertex and the lower-right vertex of the television in the environment image 1202 are recognized. In a key point pairing stage, the location coordinates (x1, y1) of the upper-left vertex of the television in the environment image 1201 is paired with the location coordinates (x1′, y1′) in the environment image 1202, and the location coordinates (x2, y2) of the lower-right vertex of the television in the environment image 1201 is paired with the location coordinates (x2′, y2′) in the environment image 1202. To be specific, after the pairing is completed, location information of the upper-left vertex of the television includes {(x1, y1), (x1′, y1′), . . . }, and location information of the lower-right vertex of the television includes {(x2, y2), (x2′, y2′), . . . }.

In the foregoing process, key point detection is performed on each environment image, and pairing is performed for a same detected image key point in different environment images, so that a camera pose of each environment image is derived based on location coordinates of the image key point in different environment images. This can improve accuracy of camera pose recognition.
903: The wearable electronic device determines a plurality of camera poses of the plurality of environment images respectively based on the location information, the camera poses being configured for indicating angle-of-view rotation attitudes of the camera during capturing of the environment images.

In some examples, because the camera inevitably shakes during rotation, a camera pose of each environment image may be re-estimated based on location information of image key points for which pairing is completed in operation 902.

In some examples, during determining of a camera pose, the wearable electronic device sets amounts of movement of the plurality of camera poses of the plurality of environment images respectively to zero; and then determines, based on the location information, amounts of rotation of the plurality of camera poses of the plurality of environment images respectively. For example, an amount of movement of a camera pose of each environment image is set to zero, and then an amount of rotation of a camera pose of each environment image is estimated based on location information of image key points for which pairing is completed.

In some examples, the wearable electronic device may estimate a camera pose by using a feature point matching algorithm. The feature point matching algorithm detects feature points (for example, the foregoing key points) in images, finds corresponding feature points between two images, and estimates a camera pose by using a geometric relationship between the feature points. Common feature point matching algorithms may include the Scale-Invariant Feature Transform (SIFT) algorithm, the Speeded Up Robust Features (SURF) algorithm, and the like.

Because an amount of movement of a camera pose is always set to zero, during adjustment of an amount of rotation of the camera pose, only the amount of rotation of the camera pose changes between different environment images, and the amount of movement does not change. This can ensure that all environment images are projected to a spherical coordinate system determined based on a same spherical center during subsequent projection of environment images, to minimize a shift and disturbance at a spherical center in a projection stage.
904: The wearable electronic device respectively projects, based on the plurality of camera poses, the plurality of environment images from an original coordinate system of the target place to a spherical coordinate system of the virtual environment to obtain a plurality of projected images.

In some examples, the wearable electronic device may directly project, based on a camera pose of each environment image in operation 903, each environment image from the original coordinate system (namely, a vertical coordinate system) to a spherical coordinate system with the center of the camera as a spherical center to obtain a projected image. The foregoing operation is performed on the plurality of environment images one by one to obtain the plurality of projected images.

In some examples, the plurality of camera poses may be further modified before the environment images are projected, so that the plurality of camera poses are aligned at the spherical center of the spherical coordinate system; and then the plurality of environment images are respectively projected from the original coordinate system to the spherical coordinate system based on a plurality of modified camera poses to obtain the plurality of projected images. For example, a camera pose is first pre-modified, and an environment image is projected as a projected image by using a modified camera pose, so that accuracy of the projected image can be further improved.

In some examples, the wearable electronic device modifies a camera pose by using a bundle adjustment algorithm. The bundle adjustment algorithm uses three-dimensional coordinates of a camera pose and a measurement point as unknown parameters and uses coordinates of a feature point that is detected in an environment image and that is used for forward intersection as observation data to perform adjustment to obtain an optimal camera pose and camera parameter (for example, a projection matrix). When the bundle adjustment algorithm is used to modify each camera pose to obtain a modified camera pose, a camera parameter can be further globally optimized to obtain an optimized camera parameter. It is assumed that a point in 3D space is observed by a plurality of cameras at different locations. The bundle adjustment algorithm is an algorithm that extracts 3D coordinates of the point and relative locations and optical information of the cameras based on angle-of-view information of the plurality of cameras. A camera pose can be optimized by using the bundle adjustment algorithm. For example, the Parallel Tracking and Mapping (PTAM) algorithm is an algorithm that optimizes a camera pose by using the bundle adjustment algorithm. A camera pose in a global process may be optimized (namely, the foregoing global optimization) by using the bundle adjustment algorithm. To be specific, a pose of the camera during long-time and long-distance movement is optimized Then each environment image is projected to the spherical coordinate system based on an optimized camera pose and camera parameter to obtain a projected image of each environment image. In addition, it can be ensured that all projected images are located in a spherical coordinate system with a same spherical center.
905: The wearable electronic device obtains a panoramic image formed by splicing the plurality of projected images, the panoramic image being an image obtained at a panoramic angle of view after the target place is projected to the virtual environment.

In some examples, the wearable electronic device directly splices the plurality of projected images in operation 904 to obtain the panoramic image. This can simplify a process of obtaining the panoramic image and improve efficiency of obtaining the panoramic image.

In some other examples, the wearable electronic device may splice the plurality of projected images to obtain a spliced image, and perform at least one of smoothing or light compensation on the spliced image to obtain the panoramic image. To be specific, the wearable electronic device performs a post-processing operation such as smoothing or light compensation on the spliced image obtained through splicing, and uses a post-processed image as the panoramic image. Smoothing on the spliced image can eliminate discontinuity at a splicing position between different projected images. Light compensation on the spliced image can balance a significant light difference at a splicing position between different projected images. FIG. 14 is an expanded view of a panoramic image. The 360-degree panoramic image can fully cover layout information of all objects (for example, indoor facilities) at the target place in the real world.

Operations 902 to 905 provide a possible implementation of obtaining, based on the plurality of environment images, a panoramic image formed by projecting the target place to the virtual environment. To be specific, operations 902 to 905 may be regarded as a panoramic image construction algorithm as a whole, input of the panoramic image construction algorithm is the plurality of environment images of the target place, and output is a 360-degree spherical-coordinate panoramic image of the target place. In addition, a random error resulting from a location change caused by camera disturbance is eliminated.

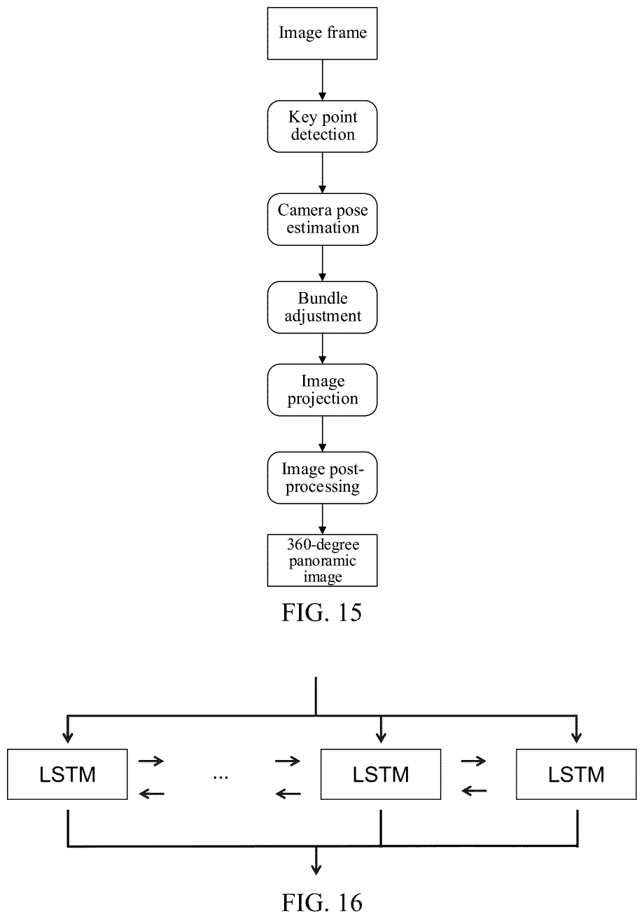

FIG. 15 shows a processing process of the panoramic image construction algorithm. For the environment images in operation 901, namely, the image frames in the video stream, key point detection is first performed on the image frames one by one to obtain a plurality of image key points in each image frame. Then pairing is performed for a same key point in different image frames to estimate a camera pose of each image frame. Then the camera pose is modified by using the bundle adjustment algorithm. Then image projection is performed by using a modified camera pose, to project the environment images from the original coordinate system to the spherical coordinate system to obtain projected images. The projected images are spliced to obtain a spliced image. A post-processing operation such as smoothing or light compensation is performed on the spliced image to obtain a final 360-degree spherical-coordinate panoramic image. The 360-degree spherical-coordinate panoramic image may be used in the following operations 906 to 908 to automatically extract layout information.
906: The wearable electronic device projects a vertical direction of the panoramic image as a gravity direction to obtain a modified panoramic image.

In some examples, the panoramic image generated in operation 905 is first preprocessed. To be specific, the vertical direction of the panoramic image is projected as the gravity direction to obtain the modified panoramic image. Assuming that a width and a height of the panoramic image are W and H respectively, the modified panoramic image obtained through preprocessing may be expressed as I∈R^{H×W}.
907: The wearable electronic device extracts an image semantic feature of the modified panoramic image, the image semantic feature being configured for representing semantic information, in the modified panoramic image, that is associated with an object (for example, indoor facilities) at the target place.

In some examples, the wearable electronic device extracts the image semantic feature of the modified panoramic image based on the modified panoramic image obtained through preprocessing in operation 906. In some examples, an image semantic feature is extracted by using a trained feature extraction model. The feature extraction model is configured to extract an image semantic feature of an input image. The modified panoramic image is inputted to the feature extraction model, and the feature extraction model outputs the image semantic feature.

In some examples, an example in which the feature extraction model is a deep neural network f is used for description. It is assumed that the deep neural network f is MobileNet, so that a high feature extraction speed can be achieved on a mobile device. In this case, the feature extraction model may be expressed as f_{mobile}. A process of extracting the image semantic feature includes the following operations A1 to A4:

A1: The wearable electronic device inputs the modified panoramic image to a feature extraction model.

In some examples, the wearable electronic device inputs the modified panoramic image obtained through preprocessing in operation 906 to the feature extraction model f_{mobile}. The feature extraction model f_{mobile} includes two types of convolutional layers: a conventional convolutional layer and a depthwise separable convolutional layer. At the conventional convolutional layer, a convolution operation is performed on an input feature map. At the depthwise separable convolutional layer, a depthwise separable convolution operation is performed on an input feature map.

A2: The wearable electronic device performs a convolution operation on the modified panoramic image through one or more convolutional layers in the feature extraction model to obtain a first feature map.

In some examples, the wearable electronic device first inputs the modified panoramic image to one or more convolutional layers (namely, conventional convolutional layers) connected in series in the feature extraction model f_{mobile}, performs a convolution operation on the modified panoramic image through the first convolutional layer to obtain an output feature map of the first convolutional layer, inputs the output feature map of the first convolutional layer to the second convolutional layer, performs a convolution operation on the output feature map of the first convolutional layer through the second convolutional layer to obtain an output feature map of the second convolutional layer, and so on, until a last convolutional layer outputs the first feature map.

A convolution kernel with a preset size is configured in each convolutional layer. For example, the preset size of the convolution kernel may be 3×3, 5×5, or 7×7. The wearable electronic device scans an output feature map of a previous convolutional layer based on a preset step through a scanning window with a preset size. At each scanning location, the scanning window can determine a group of feature values in the output feature map of the previous convolutional layer, and perform weighted summation between the group of feature values and a group of weight values of the convolution kernel respectively to obtain a feature value in an output feature map of a current convolutional layer, and so on, until the scanning window traverses all feature values in the output feature map of the previous convolutional layer. Then a new output feature map of the current convolutional layer is obtained. A convolution operation in the following descriptions is similar, and details are not described again.

A3: The wearable electronic device performs a depthwise separable convolution operation on the first feature map through one or more depthwise separable convolutional layers in the feature extraction model to obtain a second feature map.

In some examples, in addition to the conventional convolutional layer, one or more depthwise separable convolutional layers are further configured in the feature extraction model f mobile. The depthwise separable convolutional layer is configured to split a conventional convolution operation into spatial-dimension per-channel convolution and channel-dimension per-point convolution.

Any depthwise separable convolutional layer in the feature extraction model f_{mobile} is used below as an example to describe a processing process of a depthwise separable convolution operation in a single depthwise separable convolutional layer. The process includes the following sub-operations A31 to A34:

A31: The wearable electronic device performs a spatial-dimension per-channel convolution operation on an output feature map of a previous depthwise separable convolutional layer through each depthwise separable convolutional layer to obtain a first intermediate feature.

The first intermediate feature has the same dimensionality as that of the output feature map of the previous depthwise separable convolutional layer.

The per-channel convolution operation means that a single-channel convolution kernel is configured for each channel component of an input feature map in a spatial dimension, a convolution operation is performed on each channel component of the input feature map by using the single-channel convolution kernel, and convolution operation results of all channel components are combined to obtain a first intermediate feature that remains unchanged in a channel dimension.

A series relationship is kept between depthwise separable convolutional layers. To be specific, except that the first depthwise separable convolutional layer uses the first feature map as input, each of remaining depthwise separable convolutional layers uses an output feature map of a previous depthwise separable convolutional layer as input, and a last depthwise separable convolutional layer outputs the second feature map.

The first depthwise separable convolutional layer is used as an example for description. An input feature map of the first depthwise separable convolutional layer is the first feature map obtained in operation A2. Assuming that a quantity of channels of the first feature map is D, D single-channel convolution kernels are configured in the first depthwise separable convolutional layer. The D single-channel convolution kernels have a one-to-one mapping relationship with the D channels of the first feature map, and each single-channel convolution kernel is configured to perform a convolution operation only on one channel in the first feature map. A per-channel convolution operation may be performed on the D-dimensional first feature map by using the D single-channel convolution kernels to obtain a D-dimensional first intermediate feature. Therefore, the first intermediate feature has the same dimensionality as that of the first feature map. To be specific, the per-channel convolution operation does not change channel dimensionality of a feature map, and the per-channel convolution operation can fully incorporate interaction information of the first feature map in each channel.

A32: The wearable electronic device performs a channel-dimension per-point convolution operation on the first intermediate feature to obtain a second intermediate feature.

The per-point convolution operation means that a convolution operation is performed on all channels of an input feature map by using a convolution kernel, so that feature information of all the channels of the input feature map is combined into one channel. Dimensionality of the second intermediate feature can be controlled by controlling a quantity of convolution kernels in the per-point convolution operation. To be specific, the dimensionality of the second intermediate feature is equal to the quantity of convolution kernels in the per-point convolution operation.

In some examples, the wearable electronic device performs a channel-dimension per-point convolution operation on the D-dimensional first intermediate feature. To be specific, assuming that N convolution kernels are configured, for each convolution kernel, a convolution operation needs to be performed on all channels of the D-dimensional first intermediate feature by using the convolution kernel to obtain one channel of the second intermediate feature. The foregoing operation is repeated N times to perform channel-dimension per-point convolution operations by using the N convolution kernels respectively to obtain an N-dimensional second intermediate feature. Therefore, dimensionality of the second intermediate feature can be controlled by controlling the quantity N of convolution kernels, and it can be ensured that each channel of the second intermediate feature can fully integrate information of interaction between all channels of the first intermediate feature at a channel level.

A33: The wearable electronic device performs a convolution operation on the second intermediate feature to obtain an output feature map of the depthwise separable convolutional layer.

In some examples, for the second intermediate feature obtained in operation A32, a batch normalization (BN) operation may be first performed to obtain a normalized second intermediate feature, and then the normalized second intermediate feature is activated by using an activation function ReLU to obtain an activated second intermediate feature. Then a conventional convolution operation is performed on the activated second intermediate feature, and a BN operation and a ReLU activation operation are separately performed on a feature map obtained through the convolution operation to obtain an output feature map of a current depthwise separable convolutional layer. The output feature map of the current depthwise separable convolutional layer is inputted to a next depthwise separable convolutional layer, and sub-operations A31 to A33 are iteratively performed.

A34: The wearable electronic device iteratively performs the per-channel convolution operation, the per-point convolution operation, and the convolution operation, so that a last depthwise separable convolutional layer outputs the second feature map.

In some examples, for each depthwise separable convolutional layer on the wearable electronic device, except that the first depthwise separable convolutional layer performs sub-operations A31 to A33 on the first feature map, each of remaining depthwise separable convolutional layers perform sub-operations A31 to A33 on an output feature map of a previous depthwise separable convolutional layer. Finally, the last depthwise separable convolutional layer outputs the second feature map, and operation A4 is performed.

Operations A31 to A34 provide a possible implementation of extracting the second feature map through the depthwise separable convolutional layers in the feature extraction model. A person skilled in the art can flexibly control a quantity of depthwise separable convolutional layers and flexibly control a quantity of convolution kernels in each depthwise separable convolutional layer to control dimensionality of the second feature map. This is not specifically limited in examples of this application.

In some other examples, the wearable electronic device may alternatively extract the second feature map by using a dilated convolutional layer, a residual convolutional layer (namely, a conventional convolutional layer using a residual connection), or the like without using the depthwise separable convolutional layer. A manner of extracting the second feature map is not specifically limited in examples of this application.

A4: The wearable electronic device performs at least one of a pooling operation or a full connection operation on the second feature map through one or more post-processing layers in the feature extraction model to obtain the image semantic feature.

In some examples, the wearable electronic device may input the second feature map obtained in operation A3 to one or more post-processing layers, post-process the second feature map through the one or more post-processing layers, and finally output the image semantic feature. In some examples, the one or more post-processing layers include a pooling layer and a fully connected layer. In this case, the second feature map is first inputted to the pooling layer for a pooling operation. For example, when the pooling layer is an average pooling layer, an average pooling operation is performed on the second feature map; or when the pooling layer is a max pooling layer, a max pooling operation is performed on the second feature map. A type of the pooling operation is not specifically limited in the examples of this application. Then a pooled second feature map is inputted to the fully connected layer for a full connection operation to obtain the image semantic feature.

Operations A1 to A4 provide a possible implementation of extracting the image semantic feature. To be specific, the image semantic feature is extracted by using a feature extraction model based on a MobileNets architecture. In this way, a high feature extraction speed can also be achieved on a mobile device. In some other examples, feature extraction models with other architectures, such as a convolutional neural network, a deep neural network, and a residual network, may alternatively be used. An architecture of the feature extraction model is not specifically limited in the examples of this application.
908: The wearable electronic device predicts, based on the image semantic feature, layout information of the target place in the panoramic image, the layout information indicating boundary information of an object (for example, indoor facilities) at the target place.

In some examples, the wearable electronic device may input the image semantic feature extracted in operation 907 to a layout information extraction model to further automatically extract the layout information of the target place.

A layout information extraction model with a BLSTM architecture is used below as an example to describe a BLSTM-based layout information extraction process. Refer to the following operations B1 to B3:

B1: The wearable electronic device performs a channel-dimension division operation on the image semantic feature to obtain a plurality of spatial-domain semantic features.

In some examples, before the image semantic feature extracted by the feature extraction model f_{mobile} is inputted to a layout information extraction model f_{BLSTM}, a channel-dimension division operation is first performed on the image semantic feature to obtain a plurality of spatial-domain semantic features, and each spatial-domain semantic feature includes some channels of the image semantic feature. For example, a 1024-dimensional image semantic feature is divided into four 256-dimensional spatial-domain semantic features.

B2: The wearable electronic device inputs the plurality of spatial-domain semantic features to a plurality of memory units of a layout information extraction model respectively, and encodes the plurality of spatial-domain semantic features through the plurality of memory units to obtain a plurality of spatial-domain context features.

In some examples, each spatial-domain semantic feature obtained through division in operation B1 is inputted to a memory unit in the layout information extraction model f_{BLSTM}, and in each memory unit, an inputted spatial-domain semantic feature is bidirectionally encoded based on context information to obtain a spatial-domain context feature. As shown in FIG. 16, each long short-term memory (LSTM) module in FIG. 16 represents a memory unit in the layout information extraction model f_{BLSTM}, and input of each memory unit includes a spatial-domain semantic feature obtained from the image semantic feature through division, historical information from a previous memory unit (namely, preceding-context information), and future information from a next memory unit (namely, following-context information). In the BLSTM architecture, depth features of different channels in the image semantic feature of the modified panoramic image can be separately propagated in two directions through memory units, so that a spatial-domain semantic feature is fully encoded, and a spatial-domain context feature has a higher feature expression capability. In some examples, memory units at different locations may share parameters. This can significantly reduce a quantity of model parameters of the layout information extraction model f_{BLSTM}, and can also reduce storage overheads of the layout information extraction model f_{BLSTM}.

A process of encoding a single memory unit is used below as an example for description. Through each memory unit, a spatial-domain semantic feature associated with the memory unit and a spatial-domain preceding-context feature obtained through encoding by a previous memory unit may be encoded, and an encoded spatial-domain preceding-context feature is inputted to a next memory unit. In addition, the spatial-domain semantic feature associated with the memory unit and a spatial-domain following-context feature obtained through encoding by the next memory unit can be further encoded, and an encoded spatial-domain following-context feature is inputted to the previous memory unit. Then a spatial-domain context feature outputted by the memory unit is obtained based on the spatial-domain preceding-context feature and the spatial-domain following-context feature that are obtained through encoding by the memory unit.

In the foregoing process, during forward encoding, a spatial-domain semantic feature of a current memory unit is encoded in combination with a spatial-domain preceding-context feature of a previous memory unit to obtain a spatial-domain preceding-context feature of the current memory unit; and during reverse encoding, the spatial-domain semantic feature of the current memory unit is encoded in combination with a spatial-domain following-context feature of a next memory unit to obtain a spatial-domain following-context feature of the current memory unit. Then the spatial-domain preceding-context feature obtained through forward encoding and the spatial-domain following-context feature obtained through reverse encoding may be integrated to obtain a spatial-domain context feature of the current memory unit. To be specific, the memory unit (namely, each LSTM module in FIG. 16) processes the spatial-domain preceding-context feature of the previous memory unit and the spatial-domain following-context feature of the next memory unit that are inputted, to output the spatial-domain context feature of the current memory unit.

The layout information extraction model f_{BLSTM} with the BLSTM structure can better obtain global layout information of the entire modified panoramic image. This design idea is also consistent with common sense of life. To be specific, human beings can estimate layout information of other parts of a room by observing a layout of a part of the room. The layout information extraction model f_{BLSTM} integrates spatial-domain semantic information of different areas in the panoramic image, so that a room layout can be better understood from a global perspective. This helps improve accuracy of layout information in the following operation B3.

B3: The wearable electronic device decodes the plurality of spatial-domain context features to obtain the layout information.

In some examples, the wearable electronic device may decode a spatial-domain context feature obtained by each memory unit in operation B2 to obtain layout information of a target place. In some examples, the layout information may include a first layout vector, a second layout vector, and a third layout vector, the first layout vector indicating information of a junction between a wall and a ceiling at the target place, the second layout vector indicating information of a junction between a wall and a ground at the target place, and the third layout vector indicating information of a junction between walls at the target place. In this way, the spatial-domain context features obtained by the memory units are decoded into three layout vectors representing a spatial layout of the target place, so that the layout information can be quantized, and a computer can conveniently build a target virtual environment by using the layout vectors.

The wearable electronic device may process, by using a decoding unit in the layout information extraction model, the spatial-domain context features obtained by the memory units, to output the layout information. An input end of the decoding unit is connected to output ends of the memory units to receive the spatial-domain context features of the memory units. The decoding unit may include one or more network layers, for example, one or more convolutional layers, pooling layers, fully connected layers, or activation function layers. Information outputted after the spatial-domain context features of the memory units are processed by the network layers of the decoding unit is the layout information.

In some examples, the layout information including the three layout vectors may be expressed as f_{BLSTM}(f_{mobile}(I))∈R^{3×1×W}, where I represents the modified panoramic image, W represents a width of I, f_{mobile} represents the feature extraction model, f_{mobile}(I) represents the image semantic feature of the modified panoramic image, f_{BLSTM} represents the layout information extraction model, f_{BLSTM}(f_{mobile}(I)) represents the layout information of the target place. f_{BLSTM}(f_{mobile}(I)) includes three 1×W layout vectors, and the three layout vectors represent information of a junction between a wall and a ceiling, information of a junction between a wall and a ground, and information of a junction between walls respectively.

In some other examples, in addition to including the three layout vectors, the layout information of the target place can be further simplified into one layout vector and one layout scalar. To be specific, one layout vector and one layout scalar are used as the layout information of the target place. The layout vector represents a 360-degree horizontal distance from the center of the camera to a wall when the center of the camera is on the horizon. The layout scalar represents a room height (or referred to as a wall height or a ceiling height) of the target place.

A person skilled in the art may set layout information in different data forms according to service requirements, for example, set more or fewer layout vectors and layout scalars. A data form of the layout information is not specifically limited in examples of this application.

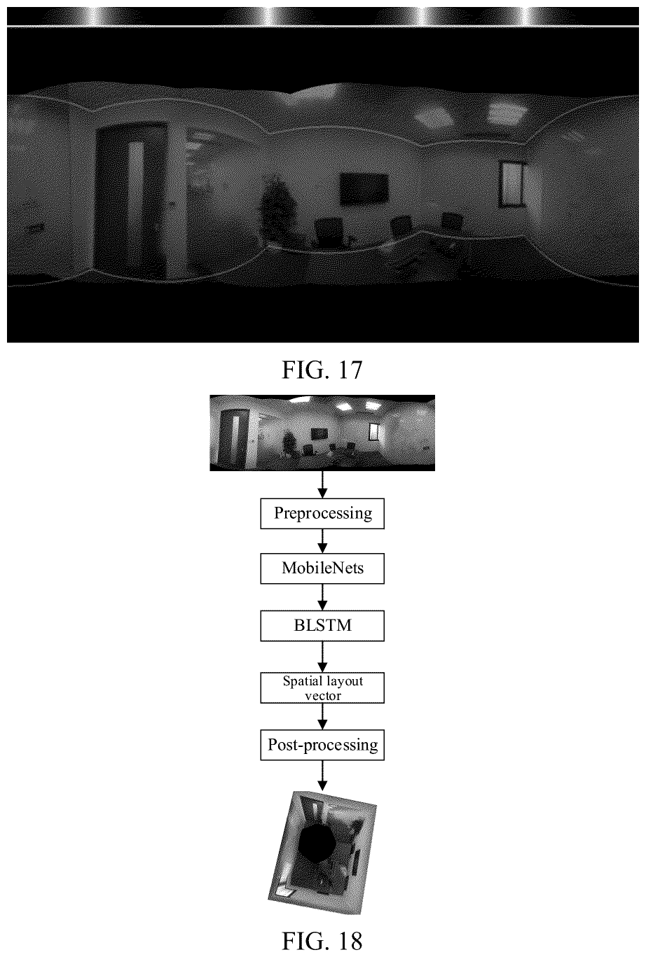

FIG. 17 shows a markup result for a spatial layout of a ceiling and a ground. Location information of a junction between the ceiling and a wall and location information of a junction between the ground and the wall can be determined by using three layout vectors. A boundary of the ceiling and a boundary of the ground in the panoramic image can be outlined by using the two pieces of location information in turn. The boundary of the ceiling is represented by a bold line in an upper part, the boundary of the ground is represented by a bold line in a lower part, and a vertical line between the ceiling and the ground represents a boundary between walls.

Operations B1 to B3 provide a possible implementation of extracting the layout information of the target place by using the layout information extraction model with the BLSTM architecture. This can improve accuracy of the layout information. In some other examples, the layout information extraction model may alternatively adopt the LSTM architecture, a recurrent neural network (RNN) architecture, or other architectures. An architecture of the layout information extraction model is not specifically limited in examples of this application.

FIG. 18 shows a principle of a processing process of obtaining three layout vectors. The 360-degree panoramic image obtained in operation 905 is first preprocessed to project a vertical direction as a gravity direction to ensure that a wall is perpendicular to a ground and walls are parallel to each other. Then an image semantic feature is extracted by using the feature extraction model MobileNet, and then a layout vector in three-dimensional space is extracted by using the layout information extraction model BLSTM. Then the layout vector in three-dimensional space may be further be post-processed to generate a target virtual environment for simulating the target place.

Operations 906 to 908 provide a possible implementation of extracting, by the wearable electronic device, the layout information of the target place in the panoramic image. The image semantic feature is extracted by using the feature extraction model, and then the layout information of the target place is predicted by using the image semantic feature. In this way, a user does not need to perform manual marking in the layout information extraction process, but the wearable electronic device performs machine recognition during the entire process. This greatly reduces labor costs and implements automated and intelligent three-dimensional spatial layout understanding for the target place.
909: The wearable electronic device displays a target virtual environment built based on the layout information, the target virtual environment being configured for simulating the target place in the virtual environment.

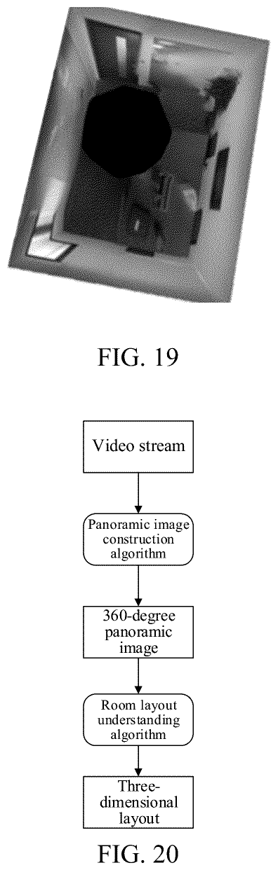

In some examples, the wearable electronic device builds, based on the layout information extracted in operation 908, the target virtual environment for simulating the target place. Then the wearable electronic device displays the target virtual environment, so that the user can feel like entering the target place in the real world in the target virtual environment. This helps provide more immersive hyper-reality interaction experience. FIG. 19 is a top view of a target virtual environment for simulating the target place. All objects (for example, indoor facilities) at the target place can be basically restored in the top view, and it is ensured that a spatial layout of the target place in the virtual environment highly restores a layout in the real world and is highly realistic. This not only improves virtual environment building efficiency, but also helps optimize immersive experience.

FIG. 20 shows a three-dimensional layout understanding process for the target place. The video stream captured by the camera of the wearable electronic device is inputted to a panoramic image construction algorithm to construct a 360-degree panoramic image. Then the 360-degree panoramic image is inputted to a room layout understanding algorithm to automatically recognize a three-dimensional layout of the target place, to be specific, three layout vectors may be outputted, so that a machine automatically builds a target virtual environment based on the three layout vectors.

In some other examples, the wearable electronic device may further perform material recognition on an object (for example, indoor facilities) at the target place based on the panoramic image to obtain a material of the object. For example, the wearable electronic device may input the panoramic image to a pre-trained material recognition model. The material recognition model processes a feature of the panoramic image, for example, performs convolution, full connection, or pooling on the feature of the panoramic image, to obtain a location of an object in the panoramic image and probability distribution of the object belonging to various preset materials (namely, a probability value of the object belonging to various materials), the location and the probability distribution being outputted by an activation function in the material recognition model. The wearable electronic device determines that a material corresponding to a largest probability value in the probability distribution is a material of the object. The material recognition model may be obtained through training based on a preset image sample and locations and materials of all objects marked in the image sample. For example, during training, the image sample is inputted to the material recognition model to obtain a predicted location of an object in the image sample and a predicted material of the object, the predicted location and the predicted material being outputted by the material recognition model. Then a loss function value is calculated based on differences between the predicted location of the object in the image sample and the predicted material of the object, and a location and a material of each object marked in the image sample. Then a weight parameter of the material recognition model is updated in a gradient descent manner based on the loss function value. The foregoing operations are repeated until a weight parameter of the material recognition model converges.

Then at least one of sound quality or a volume of audio associated with the virtual environment is modified based on the material of the object (for example, indoor facilities). For example, the wearable electronic device may set target sound quality and a target volume corresponding to a material of each type of object, and after a material of an object at the target place is determined, may modify sound quality and a volume of audio in the virtual environment to target sound quality and a target volume corresponding to a material of the object.

Sound transmitted indoors in the real world varies due to different layouts or materials of the target place. For example, door closing sound varies due to different distances between a door and a user. For another example, sound of footsteps on a wooden floor is different from sound of footsteps on a tile floor. The layout information of the target place can help determine distances between the user and various indoor facilities, to facilitate adjustment of a volume of game audio. In addition, materials of the indoor facilities can also be obtained. In this way, different spatial audio can be used during game development to provide sound quality matching indoor facilities made of different materials. This can further enhance a sense of immersion of the user during use.

All of the foregoing technical solutions can be combined in any manner to form some examples of the present disclosure. Details are not described herein.

In the method provided in the examples of this application, a panoramic image formed by projecting a target place to a virtual environment is generated based on a plurality of environment images obtained by observing the target place from different angles of view. A machine can automatically recognize and intelligently extract layout information of the target place based on the panoramic image, and build, by using the layout information, a target virtual environment for simulating the target place. In this way, because the machine can automatically extract the layout information and build the target virtual environment without manually marking the layout information by a user, an entire process takes quite a short time, and a virtual environment building speed and virtual environment loading efficiency are greatly improved. In addition, the target virtual environment can highly restore the target place, so that immersive interaction experience of a user can be improved.

Usually, a process of automatically understanding a three-dimensional layout of a target place by a machine takes only a few seconds, and a user does not need to manually mark boundary information, so that a layout information extraction speed is greatly increased. In addition, an environment image may be captured merely by using an ordinary monocular camera, without necessarily requiring that a special panoramic camera be configured or a depth sensor module be added. Therefore, the method requires low hardware costs and low energy consumption of a wearable electronic device, and can be widely deployed on wearable electronic devices with various hardware specifications.

In addition, the room layout understanding technology for a target place may be encapsulated into an interface to support various external applications such as an MR application, an XR application, a VR application, and an AR application. For example, a virtual object is placed on a virtual ground in a target virtual environment, and a virtual wall and a virtual ceiling in the target virtual environment are projected as a virtual scene to expand a field of vision of a user. In addition, based on the room layout understanding technology and the material-based spatial audio technology, a user can have more immersive interaction experience while using a wearable electronic device.

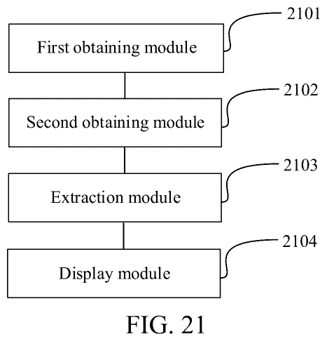

FIG. 21 is a schematic structural diagram of a virtual environment display apparatus according to an example of this application. As shown in FIG. 21, the apparatus includes:
a first obtaining module 2101, configured to obtain a plurality of environment images captured when a camera observes a target place from different angles of view, different environment images representing images captured when the camera observes the target place from different angles of view;
a second obtaining module 2102, configured to obtain, based on the plurality of environment images, a panoramic image formed by projecting the target place to a virtual environment, the panoramic image being an image obtained at a panoramic angle of view after the target place is projected to the virtual environment;
an extraction module 2103, configured to extract layout information of the target place in the panoramic image, the layout information indicating boundary information of an object (for example, indoor facilities) at the target place; and
a display module 2104, configured to display a target virtual environment built based on the layout information, the target virtual environment being configured for simulating the target place in the virtual environment.

In the apparatus provided in examples of this application, a panoramic image formed by projecting a target place to a virtual environment is generated based on a plurality of environment images obtained by observing the target place from different angles of view. A machine can automatically recognize and intelligently extract layout information of the target place based on the panoramic image, and build, by using the layout information, a target virtual environment for simulating the target place. In this way, because the machine can automatically extract the layout information and build the target virtual environment without manually marking the layout information by a user, an entire process takes quite a short time, and a virtual environment building speed and virtual environment loading efficiency are greatly improved. In addition, the target virtual environment can highly restore the target place, so that immersive interaction experience of a user can be improved.

In some examples, based on the apparatus composition in FIG. 21, the second obtaining module 2102 includes:
a detection unit, configured to perform key point detection on the plurality of environment images to obtain location information of a plurality of image key points at the target place in the plurality of environment images respectively;
a determining unit, configured to determine a plurality of camera poses of the plurality of environment images respectively based on the location information, the camera poses being configured for indicating angle-of-view rotation attitudes of the camera during capturing of the environment images;
a first projection unit, configured to respectively project, based on the plurality of camera poses, the plurality of environment images from an original coordinate system of the target place to a spherical coordinate system of the virtual environment to obtain a plurality of projected images; and
an obtaining unit, configured to obtain the panoramic image formed by splicing the plurality of projected images.

In some examples, the determining unit is configured to:
set amounts of movement of the plurality of camera poses to zero; and
determine, based on the location information, amounts of rotation of the plurality of camera poses of the plurality of environment images respectively.

In some examples, the first projection unit is configured to:
modify the plurality of camera poses, so that the plurality of camera poses are aligned at a spherical center of the spherical coordinate system; and
respectively project the plurality of environment images from the original coordinate system to the spherical coordinate system based on a plurality of modified camera poses to obtain the plurality of projected images.

In some examples, the obtaining unit is configured to:
splice the plurality of projected images to obtain a spliced image; and
perform at least one of smoothing or light compensation on the spliced image to obtain the panoramic image.

In some examples, the detection unit is configured to:
perform key point detection on each environment image to obtain location coordinates of each of a plurality of image key points in each environment image; and
pair a plurality of location coordinates of a same image key point in the plurality of environment images to obtain location information of each image key point, the location information of each image key point being configured for indicating location coordinates of each image key point in the plurality of environment images.

In some examples, based on the apparatus composition in FIG. 21, the extraction module 2103 includes:
a second projection unit, configured to project a vertical direction of the panoramic image as a gravity direction to obtain a modified panoramic image;
an extraction unit, configured to extract an image semantic feature of the modified panoramic image, the image semantic feature being configured for representing semantic information, in the modified panoramic image, that is associated with an object (for example, indoor facilities) at the target place; and
a prediction unit, configured to predict the layout information of the target place in the panoramic image based on the image semantic feature.

In some examples, based on the apparatus composition in FIG. 21, the extraction unit includes:
an input subunit, configured to input the modified panoramic image to a feature extraction model;
a first convolution subunit, configured to perform a convolution operation on the modified panoramic image through one or more convolutional layers in the feature extraction model to obtain a first feature map;
a second convolution subunit, configured to perform a depthwise separable convolution operation on the first feature map through one or more depthwise separable convolutional layers in the feature extraction model to obtain a second feature map; and
a post-processing subunit, configured to perform at least one of a pooling operation or a full connection operation on the second feature map through one or more post-processing layers in the feature extraction model to obtain the image semantic feature.

In some examples, the second convolution subunit is configured to:
perform a spatial-dimension per-channel convolution operation on an output feature map of a previous depthwise separable convolutional layer through each depthwise separable convolutional layer to obtain a first intermediate feature, the first intermediate feature having the same dimensionality as that of the output feature map of the previous depthwise separable convolutional layer;
perform a channel-dimension per-point convolution operation on the first intermediate feature to obtain a second intermediate feature;
perform a convolution operation on the second intermediate feature to obtain an output feature map of the depthwise separable convolutional layer; and
iteratively perform the per-channel convolution operation, the per-point convolution operation, and the convolution operation, so that a last depthwise separable convolutional layer outputs the second feature map.

In some examples, based on the apparatus composition in FIG. 21, the prediction unit includes:
a division subunit, configured to perform a channel-dimension division operation on the image semantic feature to obtain a plurality of spatial-domain semantic features;
an encoding subunit, configured to input the plurality of spatial-domain semantic features to a plurality of memory units of a layout information extraction model respectively, and encode the plurality of spatial-domain semantic features through the plurality of memory units to obtain a plurality of spatial-domain context features; and
a decoding subunit, configured to decode the plurality of spatial-domain context features to obtain the layout information.

In some examples, the encoding subunit is configured to:
through each memory unit, encode a spatial-domain semantic feature associated with the memory unit and a spatial-domain preceding-context feature obtained through encoding by a previous memory unit, and input an encoded spatial-domain preceding-context feature to a next memory unit;
encode the spatial-domain semantic feature associated with the memory unit and a spatial-domain following-context feature obtained through encoding by the next memory unit, and input an encoded spatial-domain following-context feature to the previous memory unit; and
obtain, based on the spatial-domain preceding-context feature and the spatial-domain following-context feature that are obtained through encoding by the memory unit, a spatial-domain context feature outputted by the memory unit.

In some examples, the first obtaining module 2101 is configured to:
obtain a video stream captured by the camera after an angle of view of the camera rotates by one circle within a target range of the target place; and
perform sampling from a plurality of image frames included in the video stream to obtain the plurality of environment images.

In some examples, the layout information includes a first layout vector, a second layout vector, and a third layout vector, the first layout vector indicating information of a junction between a wall and a ceiling at the target place, the second layout vector indicating information of a junction between a wall and a ground at the target place, and the third layout vector indicating information of a junction between walls at the target place.

In some examples, the camera is a monocular camera or a binocular camera on a wearable electronic device.

In some examples, based on the apparatus composition in FIG. 21, the apparatus further includes:
a material recognition module, configured to perform material recognition on the object (for example, indoor facilities) at the target place based on the panoramic image to obtain a material of the object; and
an audio modification module, configured to modify, based on the material of the object, at least one of sound quality or a volume of audio associated with the virtual environment.

All of the foregoing technical solutions can be combined in any manner to form some examples of the present disclosure. Details are not described herein.

When the virtual environment display apparatus provided in the foregoing examples displays the target virtual environment, the division of the foregoing functional modules is merely used as an example for description. In practical application, the functions can be allocated to and completed by different functional modules according to requirements. To be specific, an internal structure of the wearable electronic device is divided into different functional modules to complete all or some of the functions described above. In addition, the virtual environment display apparatus provided in the foregoing examples and the virtual environment display method examples belong to a same concept. For details about a specific implementation process of the virtual environment display apparatus, refer to the virtual environment display method examples. Details are not described herein again.

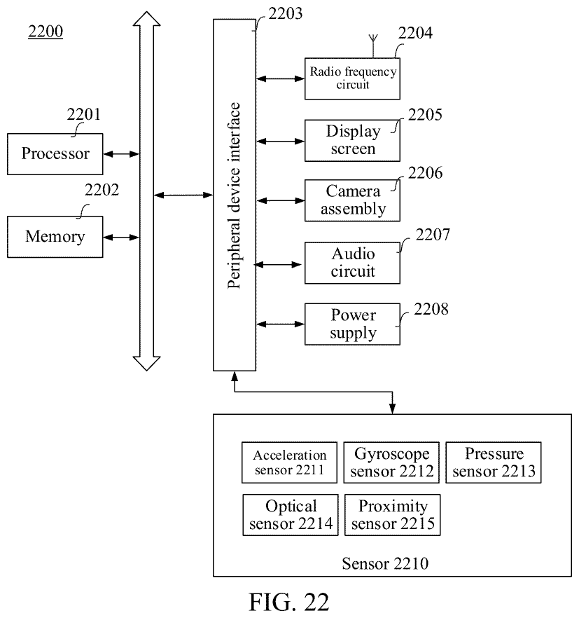

FIG. 22 is a schematic structural diagram of a wearable electronic device according to an example of this application. In some examples, a device type of the wearable electronic device 2200 includes head-mounted electronic devices such as an HMD, VR glasses, a VR helmet, and a VR eye mask, or other wearable electronic devices, or other electronic devices that support an XR technology, such as an XR device, a VR device, an AR device, and an MR device; or may be a smartphone, a tablet computer, a notebook computer, a desktop computer, a smart speaker, or a smart watch that supports the XR technology, but is not limited thereto. The wearable electronic device 2200 may also be referred to as user equipment, a portable electronic device, a wearable display device, or other names.

Usually, the wearable electronic device 2200 includes a processor 2201 and a memory 2202.

In some examples, the memory 2202 includes one or more computer-readable storage media. In some examples, the computer-readable storage medium may be non-transitory. In some examples, the memory 2202 may further include a high-speed random access memory and a non-volatile memory, for example, one or more disk storage devices or flash storage devices. In some examples, the non-transitory computer-readable storage medium in the memory 2202 is configured to store at least one instruction, and the at least one instruction is configured to be executed by the processor 2201 to implement the virtual environment display method provided in examples of this application.

In some examples, the wearable electronic device 2200 further includes a peripheral device interface 2203 and at least one peripheral device. The processor 2201, the memory 2202, and the peripheral device interface 2203 can be connected through a bus or a signal cable. Each peripheral device can be connected to the peripheral device interface 2203 through a bus, a signal cable, or a circuit board. Specifically, the peripheral device includes at least one of a radio frequency circuit 2204, a display screen 2205, a camera assembly 2206, an audio circuit 2207, and a power supply 2208.

In some examples, the wearable electronic device 2200 further includes one or more sensors 2210. The one or more sensors 2210 include but are not limited to an acceleration sensor 2211, a gyroscope sensor 2212, a pressure sensor 2213, an optical sensor 2214, and a proximity sensor 2215.

A person skilled in the art can understand that the structure shown in FIG. 22 constitutes no limitation on the wearable electronic device 2200, and the wearable electronic device can include more or fewer components than those shown in the figure, or some components may be combined, or a different component layout may be used.

In an exemplary example, a computer-readable storage medium, for example, a memory including at least one computer program, is further provided, and the at least one computer program may be executed by a processor in a wearable electronic device to complete the virtual environment display method in the foregoing examples. For example, the computer-readable storage medium includes a read-only memory (ROM), a random access memory (RAM), a compact disc read-only memory (CD-ROM), a magnetic tape, a floppy disk, and an optical data storage device.

In an exemplary example, a computer program product is further provided, including one or more computer programs, and the one or more computer programs are stored in a computer-readable storage medium. One or more processors of a wearable electronic device are capable of reading the one or more computer programs from the computer-readable storage medium, and the one or more processors execute the one or more computer programs, so that the wearable electronic device can perform the virtual environment display method in the foregoing examples.

What is claimed is:

1. A virtual environment display method, comprising:
obtaining, by a wearable electronic device, a plurality of images, wherein each of the plurality of the images is captured by a camera observing a target place from a respective different angle of view;
obtaining, by the wearable electronic device, based on the plurality of images, a panoramic image by projecting the target place to a virtual environment;
extracting, by the wearable electronic device, layout information of the target place in the panoramic image, the layout information comprising boundary information of an object at the target place; and
displaying, based on the layout information and by the wearable electronic device, a target virtual environment, the target virtual environment being a simulation of the target place in the virtual environment.

2. The method according to claim 1, wherein the obtaining the panoramic image comprises:
performing key point detection on the plurality of images to obtain location information of a plurality of image key points at the target place in the plurality of images respectively;
determining a plurality of camera poses of the plurality of images respectively based on the location information, the camera poses indicating angle-of-view rotation attitudes of the camera during capturing of the images;
respectively projecting, based on the plurality of camera poses, the plurality of images from an original coordinate system of the target place to a spherical coordinate system of the virtual environment to obtain a plurality of projected images; and
obtaining the panoramic image by splicing the plurality of projected images.

3. The method according to claim 2, wherein the determining the plurality of camera poses comprises:
setting amounts of movement of the plurality of camera poses to zero; and
determining, based on the location information, amounts of rotation of the plurality of camera poses of the plurality of images respectively.

4. The method according to claim 2, wherein the respectively projecting the plurality of environment images from the original coordinate system of the target place to the spherical coordinate system of the virtual environment comprises:
modifying the plurality of camera poses, so that the plurality of camera poses are aligned at a spherical center of the spherical coordinate system; and
respectively projecting the plurality of images from the original coordinate system to the spherical coordinate system based on a plurality of modified camera poses to obtain the plurality of projected images.

5. The method according to claim 2, wherein the obtaining the panoramic image by splicing the plurality of projected images comprises:
splicing the plurality of projected images to obtain a spliced image; and
performing at least one of smoothing or light compensation on the spliced image to obtain the panoramic image.

6. The method according to claim 2, wherein the performing key point detection comprises:
performing key point detection on each image of the plurality of images to obtain location coordinates of each of a plurality of image key points in each image; and
pairing a plurality of location coordinates of a same image key point in the plurality of images to obtain location information of each image key point, the location information of each image key point indicating location coordinates of each image key point in the plurality of images.

7. The method according to claim 1, wherein the extracting layout information of the target place in the panoramic image comprises:
projecting a vertical direction of the panoramic image as a gravity direction to obtain a modified panoramic image;
extracting an image semantic feature of the modified panoramic image, the image semantic feature representing semantic information, in the modified panoramic image, that is associated with the object at the target place; and
predicting the layout information of the target place in the panoramic image based on the image semantic feature.

8. The method according to claim 7, wherein the extracting the image semantic feature of the modified panoramic image comprises:
inputting the modified panoramic image to a feature extraction model;
performing a convolution operation on the modified panoramic image through one or more convolutional layers in the feature extraction model to obtain a first feature map;
performing a depthwise separable convolution operation on the first feature map through one or more depthwise separable convolutional layers in the feature extraction model to obtain a second feature map; and
performing at least one of a pooling operation or a full connection operation on the second feature map through one or more post-processing layers in the feature extraction model to obtain the image semantic feature.

9. The method according to claim 8, wherein the performing the depthwise separable convolution operation comprises:
performing a spatial-dimension per-channel convolution operation on an output feature map of a previous depthwise separable convolutional layer through each depthwise separable convolutional layer to obtain a first intermediate feature, the first intermediate feature having the same dimensionality as that of the output feature map of the previous depthwise separable convolutional layer;
performing a channel-dimension per-point convolution operation on the first intermediate feature to obtain a second intermediate feature;
performing a convolution operation on the second intermediate feature to obtain an output feature map of the depthwise separable convolutional layer; and
iteratively performing the per-channel convolution operation, the per-point convolution operation, and the convolution operation, so that a last depthwise separable convolutional layer outputs the second feature map.

10. The method according to claim 7, wherein the predicting the layout information of the target place in the panoramic image based on the image semantic feature comprises:
performing a channel-dimension division operation on the image semantic feature to obtain a plurality of spatial-domain semantic features;
inputting the plurality of spatial-domain semantic features to a plurality of memory units of a layout information extraction model respectively, and encoding the plurality of spatial-domain semantic features through the plurality of memory units to obtain a plurality of spatial-domain context features; and
decoding the plurality of spatial-domain context features to obtain the layout information.

11. The method according to claim 10, wherein the inputting the plurality of spatial-domain semantic features to the plurality of memory units of the layout information extraction model respectively, and the encoding the plurality of spatial-domain semantic features through the plurality of memory units to obtain the plurality of spatial-domain context features comprises:
through each memory unit, encoding a spatial-domain semantic feature associated with the memory unit and a spatial-domain preceding-context feature obtained through encoding by a previous memory unit, and inputting an encoded spatial-domain preceding-context feature to a next memory unit;
encoding the spatial-domain semantic feature associated with the memory unit and a spatial-domain following-context feature obtained through encoding by the next memory unit, and inputting an encoded spatial-domain following-context feature to the previous memory unit; and
obtaining, based on the spatial-domain preceding-context feature and the spatial-domain following-context feature that are obtained through encoding by the memory unit, a spatial-domain context feature outputted by the memory unit.

12. The method according to claim 1, wherein the obtaining the plurality of images comprises:
obtaining a video stream captured by the camera after an angle of view of the camera rotates by one circle within a target range of the target place; and
performing sampling from a plurality of image frames comprised in the video stream to obtain the plurality of images.

13. The method according to claim 1, wherein the layout information comprises a first layout vector, a second layout vector, and a third layout vector, the first layout vector indicating information of a junction between a wall and a ceiling at the target place, the second layout vector indicating information of a junction between a wall and a ground at the target place, and the third layout vector indicating information of a junction between walls at the target place.

14. The method according to claim 1, wherein the camera is a monocular camera or a binocular camera on the wearable electronic device.

15. The method according to claim 1, further comprising:
performing material recognition on the object at the target place based on the panoramic image to obtain a material of the object; and
modifying, based on the material of the object, at least one of sound quality or a volume of audio associated with the virtual environment.

16. A virtual environment display apparatus, comprising:
one or more processors; and
memory storing instructions that, when executed by the one or more processors, cause the virtual environment display apparatus to:
obtain a plurality of images, wherein each of the plurality of the images is captured by a camera observing a target place from a respective different angle of view;
obtain based on the plurality of images, a panoramic image by projecting the target place to a virtual environment;
extract layout information of the target place in the panoramic image, the layout information comprising boundary information of an object at the target place; and
display, based on the layout information, a target virtual environment, the target virtual environment being a simulation of the target place in the virtual environment.

17. The virtual environment display apparatus of claim 16, wherein the instructions, when executed, cause the virtual environment display apparatus to obtain the panoramic image by:
performing key point detection on the plurality of images to obtain location information of a plurality of image key points at the target place in the plurality of images respectively;
determining a plurality of camera poses of the plurality of images respectively based on the location information, the camera poses indicating angle-of-view rotation attitudes of the camera during capturing of the images;
respectively projecting, based on the plurality of camera poses, the plurality of images from an original coordinate system of the target place to a spherical coordinate system of the virtual environment to obtain a plurality of projected images; and
obtaining the panoramic image by splicing the plurality of projected images.

18. The virtual environment display apparatus of claim 16, wherein the virtual environment display apparatus comprises a wearable electronic device.

19. The virtual environment display apparatus of claim 16, wherein the layout information comprises a first layout vector, a second layout vector, and a third layout vector, the first layout vector indicating information of a junction between a wall and a ceiling at the target place, the second layout vector indicating information of a junction between a wall and a ground at the target place, and the third layout vector indicating information of a junction between walls at the target place.

20. A non-transitory computer-readable storage medium, when executed, cause:
obtaining a plurality of images, wherein each of the plurality of the images is captured by a camera observing a target place from a respective different angle of view;
obtaining based on the plurality of images, a panoramic image by projecting the target place to a virtual environment;
extracting layout information of the target place in the panoramic image, the layout information comprising boundary information of an object at the target place; and
displaying, based on the layout information, a target virtual environment, the target virtual environment being a simulation of the target place in the virtual environment.
